(19) United States
(12) Patent Application Publication
(10) Pub. No.: US 2025/0270129 A1
(43) Pub. Date: Aug. 28, 2025

(54) High CTE, High UV Transmittance, and High Young's Modulus Glass

(71) Applicant: Corning Incorporated, Corning, NY (US)

(72) Inventors: Jin Su Kim, Seoul (KR); Yu Xiao, Pittsford, NY (US); Liying Zhang, Painted Post, NY (US)

(21) Appl. No.: 17/775,658

(22) PCT Filed: Nov. 2, 2020
(86) PCT No.: PCT/US2020/058489

§ 371 Date: May 10, 2022

Related U.S. Application Data
(60) Provisional application No. 62/934,471, filed on Nov. 12, 2019.

(51) Int. Cl. C03C 3/085; C03C 4/00; C03C 21/00

(52) U.S. Cl. CPC C03C 3/085; C03C 4/0085; C03C 21/002

(57) ABSTRACT

A glass composition includes from about 50 mol. % to about 70 mol. % SiO₂, from about 5 mol. % to about 10 mol. % Al₂O₃, from about 10 mol. % to about 20 mol. % Na₂O, and from about 2 mol. % to about 6 mol. % K₂O, from about 0 mol. % to about 0.005 mol. % Fe₂O₃, from about 2 mol. % to about 10 mol. % ZnO, wherein the glass composition comprises R¹O and the sum of R¹O and ZnO is greater than about 4 mol. %, wherein R¹ is an alkaline earth metal, wherein the glass composition has a Young's modulus of at least 65 GPa, and wherein the glass composition has a coefficient of thermal expansion between 10.0 and 13.0 ppm/° C. The glass composition has a high ultraviolet transmission and can be used to form glass articles configured for semiconductor carrier substrates.

### CROSS-REFERENCE TO RELATED APPLICATIONS

This application claims the benefit of priority under 35 U.S.C. § 119 of U.S. Provisional Application Ser. No. 62/934,471 filed on Nov. 12, 2019, the content of which is relied upon and incorporated herein by reference to its entirety.

### TECHNICAL FIELD

This disclosure relates to glass compositions exhibiting desirable physical and chemical properties for use as carrier substrates in semiconductor packaging.

### BACKGROUND

Glass articles are used in a variety of industries, including the semiconductor packaging industry. In the semiconductor industry, fan-out wafer or panel level packaging (FO-WLP or FO-PLP) has garnered significant attention in the integrated circuit packaging technology arena due to its heterogeneous integration capability, small form factor, and total reduced system cost. Beyond applications such as baseband, power management, and radio-frequency (RF) transceivers, fan-out packaging (e.g., fan-out wafer level packaging, fan-out panel level packaging, etc.) has entered into high density fan-out applications such as application processor engines (APEs).

In contrast with standard wafer lever packaging (WLP) flows, in fan-out packaging, the silicon wafer is diced first. Afterwards, the dies are re-positioned precisely on a carrier wafer or panel, made either with glass or metal, with space for I/O and routings (where the name fan-out came from) kept around each die. The carrier with dies is then molded with epoxy molding compound, followed by a dozen or more complex steps such as deposition of redistribution of layers (RDL), bumping, debonding etc. The detailed steps vary depending on the technology used, but there is no doubt that the carrier plays an important role in fan-out process, since how well each following step performs depends on how well the carrier behaviors during the process. In-process warpage and die shift are the top challenges faced today with fan-out packaging. To keep the in-process warpage within spec, an optimized carrier CTE (coefficient of thermal expansion), which depends on many factors including chip design, the layout of the reconstituted wafer/panel, and the RDL/bump process, is required. In addition, to control the warpage, glass with high stiffness (Young's modulus) is always desired, since warpage induced by CTE mismatch scaled inversely with Young's modulus. The higher the modulus, the lower the warpage. While it may be possible to design glass with either high CTE or high Young's modulus, it is difficult to obtain glass compositions having both these characteristics. Further, to debond the packages from the carrier, generally two methods are used, that is either by using two-side thermal release tape or by applying light-to-heat conversion (LTHC) release coating with UV laser debonding. For process with LTHC coating with laser debonding, good UV transmission (>50% or >60% for example) is required for the carrier. Glass compositions having deep UV transparency may also be needed for certain applications such as silicon thinning.

Accordingly, a need exists for glass compositions having improved CTE, Young's Modulus and high UV transparency for use as carriers in semiconductor manufacturing process.

### SUMMARY

According to a first aspect, a glass composition comprises from about 50 mol. % to about 70 mol. % SiO₂, from about 5 mol. % to about 10 mol. % Al₂O₃, from about 10 mol. % to about 20 mol. % Na₂O, and from about 2 mol. % to about 6 mol. % K₂O. In certain embodiments, the glass composition has a Young's modulus of at least 65 GPa. In certain embodiments, the glass composition has a coefficient of thermal expansion between 10.0 and 13.0 ppm/° C.

In certain embodiments, the glass composition has an optical transmission of greater than about 20% over a range of wavelengths from about 250 nm to about 260 nm for a glass composition thickness of about 1.0 mm. In certain embodiments, the glass composition comprises from about 0 mol. % to about 2 mol. % B₂O₃, from about 0 mol. % to about 3 mol. % P₂O₅, from about 0 mol. % to about 0.5 mol. % Li₂O, from about 0 mol. % to about 6 mol. % MgO, from about 0 mol. % to about 3 mol. % CaO, from about 0 mol. % to about 3 mol. % SrO, from about 0 mol. % to about 0.5 mol. % SnO₂, from about 0 mol. % to about 0.005 mol. % Fe₂O₃, from about 0 mol. % to about 2 mol. % BaO, and from about 0 mol. % to about 10 mol. % ZnO. In certain embodiments, the glass composition comprises from about 0 mol. % to about 2 mol. % P₂O₅. In certain embodiments, the glass composition comprises 0 mol. % to about 0.002 mol. % Fe₂O₃. In certain embodiments, the glass composition comprises 0 mol. % BaO.

In certain embodiments, the glass composition comprises R₂O and Al₂O₃ and the difference between R₂O and Al₂O₃, that is R₂O—Al₂O₃, is from about 9 mol. % to about 15 mol. %, wherein R is an alkali metal. In certain embodiments, R is selected from Li, Na, K, or a combination thereof. In certain embodiments, R is selected from Na, K, or a combination thereof.

In certain embodiments, the glass composition comprises R¹O and ZnO and the sum of R¹O and ZnO is from about 4 mol. % to about 8 mol. %, wherein R¹ is an alkaline earth metal. In certain embodiments, R¹ is selected from Mg, Ca, Sr, Ba, or a combination thereof.

In certain embodiments, the Young's modulus of the glass composition is less than 75 GPa. In certain embodiments, the glass composition further comprises, in mole percent, between 0 and 0.005% Fe₂O₃. In certain embodiments, the glass composition further comprises, in mole percent, between 0 and 0.002% Fe₂O₃. In certain embodiments, a total alkali content is from about 12 mol. % to about 26 mol. %.

According to a second aspect, a glass article comprises a glass composition comprising from about 50 mol. % to about 70 mol. % SiO₂, from about 5 mol. % to about 10 mol. % Al₂O₃, from about 10 mol. % to about 20 mol. % Na₂O, and from about 2 mol. % to about 6 mol. % K₂O. In certain embodiments of the glass article of second aspect, the glass composition has a Young's modulus of at least 65 GPa. In certain embodiments of the glass article of second aspect, the glass composition has a coefficient of thermal expansion between 10.0 and 13.0 ppm/° C. In certain embodiments of the glass article of second aspect, the glass composition has an optical transmission of greater than about 20% over a range of wavelengths from about 250 nm to about 260 nm for a glass composition thickness of about 1.0 mm. In certain embodiments of the glass article of second aspect, the glass composition comprises from about 0 mol. % to about 2 mol. % B₂O₃, from about 0 mol. % to about 3 mol. % P₂O₅, from about 0 mol. % to about 0.5 mol. % Li₂O, from about 0 mol. % to about 6 mol. % MgO, from about 0 mol. % to about 3 mol. % CaO, from about 0 mol. % to about 3 mol. % SrO, from about 0 mol. % to about 0.5 mol. % SnO₂, from about 0 mol. % to about 0.005 mol. % Fe₂O₃, from about 0 mol. % to about 2 mol. % BaO, and from about 0 mol. % to about 10 mol. % ZnO. In certain embodiments of the glass article of second aspect, the glass composition comprises from about 0 mol. % to about 2 mol. % P₂O₅. In certain embodiments of the glass article of second aspect, the glass composition comprises 0 mol. % to about 0.002 mol. % Fe₂O₃. In certain embodiments, the glass composition comprises 0 mol. % BaO.

In certain embodiments of the glass article of second aspect, the glass composition is chemically strengthened through an ion exchange process. In certain embodiments of the glass article of second aspect, the glass article is produced by at least one of a float process, a casting process, a slot draw process or a fusion draw process.

According to a third aspect, a method for manufacturing a glass article comprises: melting a batch and forming a precursor molten glass comprising from about 50 mol. % to about 70 mol. % SiO₂, from about 5 mol. % to about 10 mol. % Al₂O₃, from about 10 mol. % to about 20 mol. % Na₂O, and from about 2 mol. % to about 6 mol. % K₂O; delivering the molten glass to a forming apparatus that has a body with an inlet that receives the molten glass which flows into a trough formed in the body and then overflows two top surfaces of the trough and runs down two sides of the body before fusing together where the two sides come together to form a glass sheet; and drawing the glass sheet using a pull roll assembly to produce said glass substrate. In certain embodiments, the glass can be melted in a refractory melter, passed through a Platinum finer, and delivered to a refractory isopipe. In certain embodiments of the method of third aspect, the glass article has a Young's modulus of at least 65 GPa. In certain embodiments of the method of third aspect, the glass article has a coefficient of thermal expansion between 10.0 and 13.0 ppm/° C. In certain embodiments, the method of third aspect includes ion exchanging the glass article in an alkali-ion containing salt bath. In certain embodiments of the method of third aspect, the alkali-ion containing salt bath comprises KNO₃, NaNO₃, or a mixture thereof. In certain embodiments of the method of third aspect, the delivering step includes managing a mass flow rate of molten glass that flows over a predetermined length at both end sections of the trough in the forming apparatus.

In certain embodiments of the method of third aspect, the glass article has an optical transmission of greater than about 20% over a range of wavelengths from about 250 nm to about 260 nm for a glass article thickness of about 1.0 mm. In certain embodiments of the method of third aspect, the glass article comprises from about 0 mol. % to about 2 mol. % B₂O₃, from about 0 mol. % to about 3 mol. % P₂O₅, from about 0 mol. % to about 0.5 mol. % Li₂O, from about 0 mol. % to about 6 mol. % MgO, from about 0 mol. % to about 3 mol. % CaO, from about 0 mol. % to about 3 mol. % SrO, from about 0 mol. % to about 0.5 mol. % SnO₂, from about 0 mol. % to about 0.005 mol. % Fe₂O₃, from about 0 mol. % to about 2 mol. % BaO, and from about 0 mol. % to about 10 mol. % ZnO. In certain embodiments of the method of third aspect, the glass article comprises from about 0 mol. % to about 2 mol. % P₂O₅. In certain embodiments of the method of third aspect, the glass article comprises 0 mol. % to about 0.002 mol. % Fe₂O₃. In certain embodiments, the glass composition comprises 0 mol. % BaO.

In certain embodiments of the method of third aspect, the glass article comprises R₂O and Al₂O₃ and the difference between R₂O and Al₂O₃, that is R₂O—Al₂O₃, is from about 9 mol. % to about 15 mol. %, wherein R is an alkali metal. In certain embodiments of the method of third aspect, R is selected from Li, Na, K, or a combination thereof. In certain embodiments of the method of third aspect, R is selected from Na, K, or a combination thereof.

In certain embodiments of the method of third aspect, the glass article comprises R¹O and ZnO and the sum of R¹O and ZnO is from about 4 mol. % to about 8 mol. %, wherein R¹ is an alkaline earth metal. In certain embodiments of the method of third aspect, R¹ is selected from Mg, Ca, Sr, Ba, or a combination thereof.

In certain embodiments of the method of third aspect, the Young's modulus of the glass article is less than 75 GPa. In certain embodiments of the method of third aspect, the glass article is chemically strengthened through an ion exchange process. In certain embodiments of the method of third aspect, the glass article is produced by at least one of a float process, a casting process, a slot draw process or a fusion draw process. In certain embodiments of the method of third aspect, the glass article further comprises, in mole percent, between 0 and 0.005% Fe₂O₃. In certain embodiments of the method of third aspect, the glass article further comprises, in mole percent, between 0 and 0.002% Fe₂O₃. In certain embodiments of the method of third aspect, a total alkali content is from about 12 mol. % to about 26 mol. %.

According to a fourth aspect, a device comprises a glass article from about 50 mol. % to about 70 mol. % SiO₂, from about 5 mol. % to about 10 mol. % Al₂O₃, from about 10 mol. % to about 20 mol. % Na₂O, and from about 2 mol. % to about 6 mol. % K₂O. In certain embodiments of the device of fourth aspect, the glass article has a Young's modulus of at least 65 GPa. In certain embodiments of the device of fourth aspect, the glass article has a coefficient of thermal expansion between 10.0 and 13.0 ppm/° C.

In certain embodiments of the device of fourth aspect, the glass article has an optical transmission of greater than about 20% over a range of wavelengths from about 250 nm to about 260 nm for a glass article thickness of about 1.0 mm. In certain embodiments of the device of fourth aspect, the glass article comprises from about 0 mol. % to about 2 mol. % B₂O₃, from about 0 mol. % to about 3 mol. % P₂O₅, from about 0 mol. % to about 0.5 mol. % Li₂O, from about 0 mol. % to about 6 mol. % MgO, from about 0 mol. % to about 3 mol. % CaO, from about 0 mol. % to about 3 mol. % SrO, from about 0 mol. % to about 0.5 mol. % SnO₂, from about 0 mol. % to about 0.005 mol. % Fe₂O₃, from about 0 mol. % to about 2 mol. % BaO, and from about 0 mol. % to about 10 mol. % ZnO. In certain embodiments of the device of fourth aspect, the glass article comprises from about 0 mol. % to about 2 mol. % P₂O₅. In certain embodiments of the device of fourth aspect, the glass article comprises 0 mol. % to about 0.002 mol. % Fe₂O₃. In certain embodiments, the glass composition comprises 0 mol. % BaO.

In certain embodiments of the device of fourth aspect, the glass article comprises R₂O and Al₂O₃ and the difference between R₂O and Al₂O₃, that is R₂O—Al₂O₃, is from about 9 mol. % to about 15 mol. %, wherein R is an alkali metal. In certain embodiments of the device of fourth aspect, R is selected from Li, Na, K, or a combination thereof. In certain embodiments of the device of fourth aspect, R is selected from Na, K, or a combination thereof.

In certain embodiments of the device of fourth aspect, the glass article comprises R¹O and ZnO and the sum of R¹O and ZnO is from about 4 mol. % to about 8 mol. %, wherein R¹ is an alkaline earth metal. In certain embodiments, R¹ is selected from Mg, Ca, Sr, Ba, or a combination thereof.

In certain embodiments of the device of fourth aspect, the Young's modulus of the glass article is less than 75 GPa. In certain embodiments of the device of fourth aspect, the glass article is chemically strengthened through an ion exchange process. In certain embodiments of the device of fourth aspect, the glass article is produced by at least one of a float process, a casting process, a slot draw process or a fusion draw process. In certain embodiments of the device of fourth aspect, the glass article further comprises, in mole percent, between 0 and 0.005% Fe₂O₃. In certain embodiments of the device of fourth aspect, the glass article further comprises, in mole percent, between 0 and 0.002% Fe₂O₃. In certain embodiments of the device of fourth aspect, a total alkali content is from about 12 mol. % to about 26 mol. %. In certain embodiments of the device of fourth aspect, the device is an electronic device, an automotive device, an architectural device, or an appliance device.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a cross-sectional schematic view of a portion of a glass article in accordance with one or more embodiments shown and described herein;

FIG. 2 illustrates a schematic flow diagram of a fan-out wafer level packaging process in accordance with one or more embodiments shown and described herein;

FIG. 3 illustrates a graph of the optical transmission (in %; Y-axis) as a function of wavelength (in nm; X-axis) for exemplary glass articles in accordance with one or more embodiments shown and described herein.

FIG. 4 illustrates a graph of the transmission of 254 nm light (in %; Y-axis) as a function of Fe₂O₃ concentration (in mol. %; X-axis) for exemplary glass articles in accordance with one or more embodiments shown and described herein.

Like reference numbers and designations in the various drawings indicate like elements.

### DETAILED DESCRIPTION

Reference will now be made in detail to various embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As discussed above, the present disclosure is concerned with improved glass compositions with high CTE and a high Young's modulus, glass articles formed from the same, and methods for making and using the same. Many semiconductor applications require Li-free glass, since Li can be very diffusive and can potentially contaminate other components. Barium is known to possess environmental concerns and is costly compared to other alkaline earth materials. The glass compositions described herein are lithium-free and/or barium-free, and have high CTE and a high Young's modulus and can be used to form glass articles for use in making carrier substrates for semiconductor applications. Due to the high average coefficient of thermal expansion and high Young's modulus, the glass composition is particularly well suited for use as a glass article, such as a carrier glass for fan-out wafer/panel level packaging (FO-WLP or FO-PLP). Specifically, some embodiments described herein relate to glass compositions and articles having a CTE between 10.0 and 13.0 ppm/° C. and a Young's modulus of between 65 GPa and 75 GPa and methods for making and using the same. Some embodiments described herein relate to glass compositions and articles having an optical transmission of greater than 20% over a range of wavelengths from 250 nm to 260 nm for a glass composition thickness of about 1.0 mm and methods for making and using the same.

### Compositions

The glass composition may include a base composition which is essentially an alkali aluminosilicate. Thus, the base compositions of the glass may generally include a combination of SiO₂, Al₂O₃, Na₂O, and K₂O. The glass compositions may further include at least one alkaline earth oxides such as, MgO, CaO, SrO, and optionally BaO. In certain embodiments, the glass composition is free of BaO. The glass compositions may include additional alkali metal oxides, such as Li₂O. In some embodiments, the glass composition may further include one or more additional oxides, such as, by way of example and not limitation, B₂O₃, P₂O₅, SnO₂, Fe₂O₃, ZnO or the like. SnO₂ can be added as a fining agent and/or to further modify the CTE of the glass composition. P₂O₅ can help stabilize the alkali oxides and improve the refractory (e.g., zircon) compatibility.

In various embodiments, the glass composition generally includes SiO₂ in an amount from about 50 mol. % to about 70 mol. %. When the content of SiO₂ is too small, the glass may have poor chemical and mechanical durability. On the other hand, when the content of SiO₂ is too large, melting ability of the glass decreases and the viscosity increases, so forming of the glass becomes difficult. In some embodiments, SiO₂ is present in the glass composition in an amount from about 50 mol. % to about 70 mol. %, such as from about 50 mol. % to about 65 mol. %, from about 50 mol. % to about 60 mol. %, from about 50 mol. % to about 55 mol. %, from about 55 mol. % to about 70 mol. %, from about 55 mol. % to about 65 mol. %, from about 55 mol. % to about 60 mol. %, from about 60 mol. % to about 70 mol. %, from about 60 mol. % to about 65 mol. %, or from about 65 mol. % to about 70 mol. %, or any range including and/or in-between any two of these values.

The glass composition may also include Al₂O₃. Al₂O₃, in conjunction with alkali oxides present in the glass composition, such as Na₂O, K₂O or the like, improves the susceptibility of the glass to ion exchange strengthening. Moreover, increased amounts of Al₂O₃ may also increase the softening point of the glass, thereby reducing the formability of the glass. The glass compositions described herein may include Al₂O₃ in an amount from about 5 mol. % to about 10 mol. %, such as from about 5 mol. % to about 9 mol. %, from about 5 mol. % to about 8 mol. %, from about 5 mol. % to about 7 mol. %, from about 5 mol. % to about 6 mol. %, from about 6 mol. % to about 10 mol. %, from about 6 mol. % to about 9 mol. %, from about 6 mol. % to about 8 mol. %, from about 6 mol. % to about 7 mol. %, from about 7 mol. % to about 10 mol. %, from about 7 mol. % to about 9 mol. %, from about 7 mol. % to about 8 mol. %, from about 8 mol. % to about 10 mol. %, from about 8 mol. % to about 9 mol. %, or from about 9 mol. % to about 10 mol. %, or any range including and/or in-between any two of these values.

Embodiments of the glass composition may further include one or more alkali oxides (e.g., Na₂O, K₂O, Li₂O, or the like). The alkali oxides facilitate the melting of the glass composition and lower the softening point of the glass, thereby offsetting the increase in the softening point due to higher concentrations of SiO₂ and/or Al₂O₃ in the glass composition. The alkali oxides also assist in improving the chemical durability of the glass composition and tuning the CTE to a desired value. In all of the glass compositions described herein, the alkali oxides include at least Na₂O and K₂O. Some embodiments the alkali oxides further include Li₂O.

In various embodiments, the total alkali content in the glass composition is from about 12 mol. % to about 26 mol. %. The total alkali content can include the total mol. % of alkali metals in the glass composition. For example, the total alkali content can include the total mol. % of any one of Li, Na, K, or a combination of any two or more thereof in the glass composition. In some embodiments, the total alkali content is an amount from about 12 mol. % to about 26 mol. %, such as from about 12 mol. % to about 23 mol. %, from about 12 mol. % to about 20 mol. %, from about 12 mol. % to about 15 mol. %, from about 15 mol. % to about 26 mol. %, from about 15 mol. % to about 23 mol. %, from about 15 mol. % to about 20 mol. %, from about 20 mol. % to about 26 mol. %, from about 20 mol. % to about 23 mol. %, or from about 23 mol. % to about 26 mol. %, or any range including and/or in-between any two of these values.

In various embodiments, the glass compositions include from about 10 mol. % Na₂O to about 25 mol. % Na₂O, such as from about 10 mol. % Na₂O to about 22 mol. % Na₂O, from about 10 mol. % Na₂O to about 20 mol. % Na₂O, from about 10 mol. % Na₂O to about 14 mol. % Na₂O, from about 14 mol. % Na₂O to about 25 mol. % Na₂O, from about 14 mol. % Na₂O to about 22 mol. % Na₂O, from about 14 mol. % Na₂O to about 20 mol. % Na₂O, from about 18 mol. % Na₂O to about 20 mol. % Na₂O, from about 18 mol. % Na₂O to about 22 mol. % Na₂O, or from about 22 mol. % Na₂O to about 25 mol. % Na₂O, or any range including and/or in-between any two of these values.

In various embodiments, the glass compositions include from about 2 mol. % K₂O to about 6 mol. % K₂O, such as from about 2 mol. % K₂O to about 5 mol. % K₂O, from about 2 mol. % K₂O to about 4 mol. % K₂O, from about 2 mol. % K₂O to about 3 mol. % K₂O, from about 3 mol. % K₂O to about 6 mol. % K₂O, from about 3 mol. % K₂O to about 5 mol. % K₂O, from about 3 mol. % K₂O to about 4 mol. % K₂O, from about 4 mol. % K₂O to about 6 mol. % K₂O, from about 4 mol. % K₂O to about 5 mol. % K₂O, or from about 5 mol. % K₂O to about 6 mol. % K₂O, or any range including and/or in-between any two of these values.

In various embodiments, the glass compositions include from about 0 mol. % Li₂O to about 0.5 mol. % Li₂O, such as from about 0 mol. % Li₂O to about 0.4 mol. % Li₂O, from about 0 mol. % Li₂O to about 0.4 mol. % Li₂O, from about 0 mol. % Li₂O to about 0.3 mol. % Li₂O, from about 0 mol. % Li₂O to about 0.2 mol. % Li₂O, from about 0 mol. % Li₂O to about 0.1 mol. % Li₂O, from about 0.1 mol. % Li₂O to about 0.5 mol. % Li₂O, from about 0.1 mol. % Li₂O to about 0.4 mol. % Li₂O, from about 0.1 mol. % Li₂O to about 0.3 mol. % Li₂O, from about 0.1 mol. % Li₂O to about 0.2 mol. % Li₂O, from about 0.2 mol. % Li₂O to about 0.5 mol. % Li₂O, from about 0.2 mol. % Li₂O to about 0.4 mol. % Li₂O, from about 0.2 mol. % Li₂O to about 0.3 mol. % Li₂O, from about 0.3 mol. % Li₂O to about 0.5 mol. % Li₂O, from about 0.3 mol. % Li₂O to about 0.4 mol. % Li₂O, or from about 0.4 mol. % Li₂O to about 0.5 mol. % Li₂O, or any range including and/or in-between any two of these values. In some embodiments, the glass compositions may be free from lithium and compounds containing lithium.

In some embodiments, the glass compositions include one or more alkali metal oxides (R₂O) as described herein. In various embodiments, the glass composition comprises R₂O and Al₂O₃ and the difference between R₂O and Al₂O₃, that is R₂O minus Al₂O₃, is from about 9 mol. % to about 15 mol. %, wherein R is an alkali metal. For example, R can be selected from Li, Na, K, or a combination of any two or more thereof. In certain embodiments of the device of fourth aspect, R is selected from Na, K, or a combination thereof. In some embodiments, the difference between R₂O and Al₂O₃, that is R₂O—Al₂O₃, is an amount from about 9 mol. % to about 15 mol. %, such as from about 10 mol. % to about 15 mol. %, from about 11 mol. % to about 15 mol. %, from about 12 mol. % to about 15 mol. %, from about 13 mol. % to about 15 mol. %, from about 14 mol. % to about 15 mol. %, from about 9 mol. % to about 14 mol. %, from about 10 mol. % to about 14 mol. %, from about 11 mol. % to about 14 mol. %, from about 12 mol. % to about 14 mol. %, from about 13 mol. % to about 14 mol. %, from about 9 mol. % to about 13 mol. %, from about 10 mol. % to about 13 mol. %, from about 11 mol. % to about 13 mol. %, from about 12 mol. % to about 13 mol. %, from about 9 mol. % to about 12 mol. %, from about 10 mol. % to about 12 mol. %, from about 11 mol. % to about 12 mol. %, from about 9 mol. % to about 11 mol. %, from about 10 mol. % to about 11 mol. %, or from about 9 mol. % to about 10 mol. %, or any range including and/or in-between any two of these values.

Embodiments of the glass compositions may further include one or more alkaline earth oxides. The alkaline earth oxide may include, for example, MgO, CaO, SrO, BaO, or combinations thereof. In certain embodiments, the glass composition is free of BaO. Alkaline earth oxides improve the meltability of the glass batch oxides and increase the chemical durability of the glass composition, in addition to influencing the CTE.

In various embodiments, the glass compositions include from about 0 mol. % MgO to about 6 mol. % MgO, such as from about 0 mol. % MgO to about 5 mol. % MgO, from about 0 mol. % MgO to about 4 mol. % MgO, from about 0 mol. % MgO to about 3 mol. % MgO, from about 0 mol. % MgO to about 2 mol. % MgO, from about 0 mol. % MgO to about 1 mol. % MgO, from about 1 mol. % MgO to about 6 mol. % MgO, from about 1 mol. % MgO to about 5 mol. % MgO, from about 1 mol. % MgO to about 4 mol. % MgO, from about 1 mol. % MgO to about 3 mol. % MgO, from about 1 mol. % MgO to about 2 mol. % MgO, from about 2 mol. % MgO to about 6 mol. % MgO, from about 2 mol. % MgO to about 5 mol. % MgO, from about 2 mol. % MgO to about 4 mol. % MgO, from about 2 mol. % MgO to about 3 mol. % MgO, from about 3 mol. % MgO to about 6 mol. % MgO, from about 3 mol. % MgO to about 5 mol. % MgO, from about 3 mol. % MgO to about 4 mol. % MgO, from about 4 mol. % MgO to about 6 mol. % MgO, from about 4 mol. % MgO to about 5 mol. % MgO, or from about 5 mol. % MgO to about 6 mol. % MgO, or any range including and/or in-between any two of these values. In some embodiments, the glass compositions may be free from magnesium and compounds containing magnesium.

In various embodiments, the glass compositions include from about 0 mol. % CaO to about 3 mol. % CaO, such as from about 0 mol. % CaO to about 2 mol. % CaO, from about 0 mol. % CaO to about 1 mol. % CaO, from about 1 mol. % CaO to about 3 mol. % CaO, from about 1 mol. % CaO to about 2 mol. % CaO, or from about 2 mol. % CaO to about 3 mol. % CaO, or any range including and/or in-between any two of these values. In some embodiments, the glass compositions may be free from calcium and compounds containing calcium.

In various embodiments, the glass compositions include from about 0 mol. % SrO to about 3 mol. % SrO, such as from about 0 mol. % SrO to about 2 mol. % SrO, from about 0 mol. % SrO to about 1 mol. % SrO, from about 1 mol. % SrO to about 3 mol. % SrO, from about 1 mol. % SrO to about 2 mol. % SrO, or from about 2 mol. % SrO to about 3 mol. % SrO, or any range including and/or in-between any two of these values. In some embodiments, the glass compositions may be free from strontium and compounds containing strontium.

In various embodiments, the glass compositions include from about 0 mol. % BaO to about 2 mol. % BaO, such as from about 0 mol. % BaO to about 1.5 mol. % BaO, from about 0 mol. % BaO to about 1 mol. % BaO, from about 0 mol. % BaO to about 0.5 mol. % BaO, from about 0.5 mol. % BaO to about 2 mol. % BaO, from about 0.5 mol. % BaO to about 1.5 mol. % BaO, from about 0.5 mol. % BaO to about 1 mol. % BaO, from about 1 mol. % BaO to about 2 mol. % BaO, from about 1 mol. % BaO to about 1.5 mol. % BaO, or from about 1.5 mol. % BaO to about 2 mol. % BaO, or any range including and/or in-between any two of these values. In certain embodiments, the glass composition comprises 0 mol. % BaO. In some embodiments, the glass compositions may be free from barium and compounds containing barium.

Other metal oxides may additionally be included in the glass compositions of some embodiments. For example, the glass composition may further include ZnO which improves the resistance of the glass composition to chemical attack. For example, in various embodiments, the glass compositions include from about 0 mol. % ZnO to about 10 mol. % ZnO, such as from about 0 mol. % ZnO to about 8 mol. % ZnO, from about 0 mol. % ZnO to about 6 mol. % ZnO, from about 0 mol. % ZnO to about 4 mol. % ZnO, from about 0 mol. % ZnO to about 2 mol. % ZnO, from about 2 mol. % ZnO to about 10 mol. % ZnO, from about 2 mol. % ZnO to about 8 mol. % ZnO, from about 2 mol. % ZnO to about 6 mol. % ZnO, from about 2 mol. % ZnO to about 4 mol. % ZnO, from about 4 mol. % ZnO to about 10 mol. % ZnO, from about 4 mol. % ZnO to about 8 mol. % ZnO, from about 4 mol. % ZnO to about 6 mol. % ZnO, from about 6 mol. % ZnO to about 10 mol. % ZnO, from about 6 mol. % ZnO to about 8 mol. % ZnO, or from about 8 mol. % ZnO to about 10 mol. % ZnO, or any range including and/or in-between any two of these values. In some embodiments, the glass compositions may be free from zinc and compounds containing zinc.

In some embodiments, the glass compositions include one or more alkaline earth metal oxides (R¹O), as described herein. In various embodiments, the glass composition comprises R¹O and ZnO and the sum of R¹O and ZnO is from about 4 mol. % to about 8 mol. %, wherein R¹ is an alkaline earth metal. For example, R¹ can be selected from Mg, Ca, Sr, Ba, or a combination of any two or more thereof. In some embodiments, the sum of R¹O and ZnO is an amount from about 4 mol. % to about 8 mol. %, such as from about 4 mol. % to about 7 mol. %, from about 4 mol. % to about 6 mol. %, from about 4 mol. % to about 5 mol. %, from about 5 mol. % to about 8 mol. %, from about 5 mol. % to about 7 mol. %, from about 5 mol. % to about 6 mol. %, from about 6 mol. % to about 8 mol. %, from about 6 mol. % to about 7 mol. %, or from about 7 mol. % to about 8 mol. %, or any range including and/or in-between any two of these values.

In some embodiments described herein, the boron concentration in the glass compositions from which the glass compositions are formed is a flux which may be added to glass compositions to make the viscosity-temperature curve less steep as well as lowering the entire curve, thereby improving the formability of the glass and softening the glass. In various embodiments, the glass compositions include from about 0 mol. % B₂O₃ to about 3 mol. % B₂O₃, such as from about 0 mol. % B₂O₃ to about 2.5 mol. % B₂O₃, from about 0 mol. % B₂O₃ to about 2 mol. % B₂O₃, from about 0 mol. % B₂O₃ to about 1.5 mol. % B₂O₃, from about 0 mol. % B₂O₃ to about 0.5 mol. % B₂O₃, 0.5 mol. % B₂O₃ to about 3 mol. % B₂O₃, from about 0.5 mol. % B₂O₃ to about 2.5 mol. % B₂O₃, from about 0.5 mol. % B₂O₃ to about 2 mol. % B₂O₃, from about 0.5 mol. % B₂O₃ to about 1.5 mol. % B₂O₃, 1.5 mol. % B₂O₃ to about 3 mol. % B₂O₃, from about 1.5 mol. % B₂O₃ to about 2.5 mol. % B₂O₃, from about 1.5 mol. % B₂O₃ to about 2 mol. % B₂O₃, 2 mol. % B₂O₃ to about 3 mol. % B₂O₃, from about 2 mol. % B₂O₃ to about 2.5 mol. % B₂O₃, or 2.5 mol. % B₂O₃ to about 3 mol. % B₂O₃, or any range including and/or in-between any two of these values. In some embodiments, the glass compositions may be free from boron and compounds containing boron.

In some embodiments, the glass compositions may include an agent to stabilize the alkali oxides and improve the refractory (e.g., zircon) compatibility. In various embodiments, the glass compositions include from about 0 mol. % P₂O₅ to about 3 mol. % P₂O₅, such as from about 0 mol. % P₂O₅ to about 2 mol. % P₂O₅, from about 0 mol. % P₂O₅ to about 1 mol. % P₂O₅, from about 1 mol. % P₂O₅ to about 3 mol. % P₂O₅, from about 1 mol. % P₂O₅ to about 2 mol. % P₂O₅, from about 2 mol. % P₂O₅ to about 3 mol. % P₂O₅, or from about 0.1 mol. % P₂O₅ to about 3 mol. % P₂O₅, or any range including and/or in-between any two of these values.

In various embodiments, the glass compositions may include a fining agent (e.g., SnO₂, Sb₂O₃, As₂O₃, and/or halogens such as F⁻, and/or Cl⁻). When a fining agent is present in the glass composition, the fining agent may be present in amount less than or equal to 1 wt. % or even less than or equal to 0.5 wt. %. When the content of the fining agent is too large, the fining agent may enter the glass structure and affect various glass properties. However, when the content of the fining agent is too low, the glass may have poor quality due to high level of blisters.

For example, in various embodiments, the glass compositions include from about 0 mol. % SnO₂ to about 0.5 mol. % SnO₂, such as from about 0 mol. % SnO₂ to about 0.4 mol. % SnO₂, from about 0 mol. % SnO₂ to about 0.3 mol. % SnO₂, from about 0 mol. % SnO₂ to about 0.2 mol. % SnO₂, from about 0 mol. % SnO₂ to about 0.1 mol. % SnO₂, from about 0.1 mol. % SnO₂ to about 0.5 mol. % SnO₂, from about 0.1 mol. % SnO₂ to about 0.4 mol. % SnO₂, from about 0.1 mol. % SnO₂ to about 0.3 mol. % SnO₂, from about 0.1 mol. % SnO₂ to about 0.2 mol. % SnO₂, from about 0.2 mol. % SnO₂ to about 0.5 mol. % SnO₂, from about 0.2 mol. % SnO₂ to about 0.4 mol. % SnO₂, from about 0.2 mol. % SnO₂ to about 0.3 mol. % SnO₂, from about 0.3 mol. % SnO₂ to about 0.5 mol. % SnO₂, from about 0.3 mol. % SnO₂ to about 0.4 mol. % SnO₂, or from about 0.4 mol. % SnO₂ to about 0.5 mol. % SnO₂, or any range including and/or in-between any two of these values. In some embodiments, the glass compositions may be free from tin and compounds containing tin.

In various embodiments, the glass composition may be substantially free of transition metals, such as iron and lanthanides such as cerium. Without being bound by theory, it is believed that by avoiding the use of such elements in the glass compositions, the optical transmission of the glass across near UV wavelengths can be increased. The increased UV transmission can enable or improve the use of UV-debonding, such as the use of UV-debonding layers positioned between a glass carrier and semiconductor chip components.

In some embodiments, the glass composition may be free from iron and compounds containing iron. In some embodiments, the glass composition may include a small amount of iron or an iron containing compound such as iron oxide. For example, in various embodiments, the glass compositions include from about 0 mol. % Fe₂O₃ to about 0.005 mol. % Fe₂O₃, such as from about 0 mol. % Fe₂O₃ to about 0.004 mol. % Fe₂O₃, from about 0 mol. % Fe₂O₃ to about 0.003 mol. % Fe₂O₃, from about 0 mol. % Fe₂O₃ to about 0.002 mol. % Fe₂O₃, from about 0 mol. % Fe₂O₃ to about 0.001 mol. % Fe₂O₃, from about 0.001 mol. % Fe₂O₃ to about 0.005 mol. % Fe₂O₃, from about 0.001 mol. % Fe₂O₃ to about 0.004 mol. % Fe₂O₃, from about 0.001 mol. % Fe₂O₃ to about 0.003 mol. % Fe₂O₃, from about 0.001 mol. % Fe₂O₃ to about 0.002 mol. % Fe₂O₃, from about 0.002 mol. % Fe₂O₃ to about 0.005 mol. % Fe₂O₃, from about 0.002 mol. % Fe₂O₃ to about 0.004 mol. % Fe₂O₃, from about 0.002 mol. % Fe₂O₃ to about 0.003 mol. % Fe₂O₃, from about 0.003 mol. % Fe₂O₃ to about 0.005 mol. % Fe₂O₃, from about 0.003 mol. % Fe₂O₃ to about 0.004 mol. % Fe₂O₃, or from about 0.004 mol. % Fe₂O₃ to about 0.005 mol. % Fe₂O₃, or any range including and/or in-between any two of these values.

In some embodiments, the glass composition includes from about 50 mol. % to about 70 mol. % SiO₂; from about 5 mol. % to about 10 mol. % Al₂O₃; from about 10 mol. % to about 25 mol. % Na₂O; and from about 2 mol. % to about 6 mol. % K₂O. In some embodiments, the glass composition further includes from about 0 mol. % to about 2 mol. % B₂O₃; from about 0 mol. % to about 3 mol. % P₂O₅; from about 0 mol. % to about 0.5 mol. % Li₂O; from about 0 mol. % to about 6 mol. % MgO; from about 0 mol. % to about 3 mol. % CaO; from about 0 mol. % to about 3 mol. % SrO; from about 0 mol. % to about 0.5 mol. % SnO₂; from about 0 mol. % to about 0.005 mol. % Fe₂O₃; from about 0 mol. % to about 2 mol. % BaO; and from about 0 mol. % to about 8 mol. % ZnO. In some embodiments, the glass composition includes from about 0 mol. % to about 2 mol. % P₂O₅. In some embodiments, the glass composition of claim 3, further comprising from about 0 mol. % to about 0.002 mol. % Fe₂O₃. In certain embodiments, the glass composition comprises 0 mol. % BaO.

In various embodiments, the glass composition has a Young's modulus of greater than 65 GPa, which may minimize flexing of the glass during processing and prevent damage to devices attached to the glass, such as when the glass is used as a carrier substrate for electronic devices. In some embodiments, the glass composition has a Young's modulus of greater than 65 GPa, greater than 66 GPa, greater than 67 GPa, greater than 68 GPa, greater than 69 GPa, or greater than 70 GPa. In some embodiments, the glass composition has a Young's modulus of less than 75 GPa, less than 74 GPa, less than 73 GPa, less than 72 GPa, or less than 71 GPa. In some particular embodiments, the glass composition has a Young's modulus from about 65 GPa to about 75 GPa, such as from about 65 GPa to about 70 GPa, from about 70 GPa to 75 GPa, or any range including and/or in-between any two of these values. However, it is contemplated that desired properties, including the Young's modulus, may vary depending on the particular embodiment, end use, and processing requirements for the glass composition. A Young's modulus above 68 GPa can be achieved without using any rare earth oxides in the compositions. Alternatively, the Young's modulus of the glass compositions can be further increased by adding small amount of rare earth oxide, such as for example, about 0 mol. % to about 3 mol. % of one or more of Y₂O₃, La₂O₃, ZrO₂, TiO₂, BeO or Ta₂O₅.

In various embodiments, the glass composition has a coefficient of thermal expansion (CTE) of greater than 10 ppm/° C., which may reduce in-process warpage of the die. In some embodiments, the glass composition has a CTE from 10 ppm/° C. to 13 ppm/° C., from 10 ppm/° C. to 12 ppm/° C., from 10 ppm/° C. to 11 ppm/° C., from 11 ppm/° C. to 13 ppm/° C., from 11 ppm/° C. to 12 ppm/° C. or from 12 ppm/° C. to 13 ppm/° C., or any range including and/or in-between any two of these values.

In some embodiments, the glass composition has a liquidus viscosity suitable for forming high quality glass sheets using a fusion draw process as described herein. The higher liquidus viscosity allows bigger operational window in forming during glass manufacturing. For example, each of the glass compositions may have a liquidus viscosity of at least about 70 kP at least about 100 kP, at least about 200 kP, or at least about 300 kP. Additionally or alternatively, each of the glass compositions comprises a liquidus viscosity of less than about 3000 kP, less than about 2500 kP, less than about 1000 kP, or less than about 800 kP. In some embodiments, the glass composition may have a liquidus viscosity from about 70 kP to about 3000 kP, such as from about 70 kP to about 3000 kP, about 100 kP to about 2500 kP, about 200 kP to about 2000 kP or about 200 kP to about 800 kP, or any range including and/or in-between any two of these values.

In some embodiments, the purity of the raw materials used in the glass compositions may be controlled to enable optical transmission of greater than 20% over a range of wavelengths from about 250 nm to about 260 nm for a glass article thickness of 1 mm, wherein the glass article includes the glass composition described herein.

The glass compositions of the present disclosure advantageously possess high CTE, high Young's modulus, deep UV transmission, and improved chemical durability while maintaining the melting and forming performance of the glass. The glass compositions of the present disclosure are soft and can be 3-D formed and used in applications that require complex shapes. The glass compositions of the present disclosure can also be used as glass carrier for Fan-out packaging. Further, the glass compositions are free of contamination, environmentally friendly and cost effective. The glass compositions, because of their high Young's Modulus, have less warpage and are less prone to bucking. The glass compositions may optionally include additional components useful in modifying the physical and chemical properties of the glass, e.g., refractive index, glass stability, chemical durability, etc. For example, in various embodiments, the inclusion of one or more alkali oxides in the glass compositions can enable the glass compositions to be ion exchanged according to methods known and used in the art. In some embodiments, the glass composition is chemically strengthened through an ion exchange process. Ion exchanging may further strengthen the glass composition and alter the stresses in the glass article formed from the glass composition. However, in some embodiments, the glass article formed from the glass composition is not ion exchanged, since ion exchange may result in dimensional changes or warpage of the glass article.

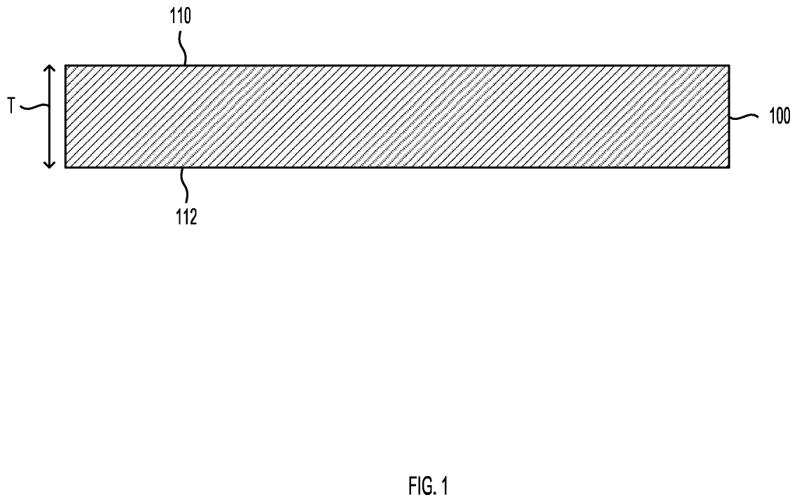

According to some embodiments, a glass article may be formed from the glass compositions described herein. Referring now to FIG. 1 by way of example, a cross section of a portion of a glass article 100 formed from the high CTE, high Young's modulus glass compositions is schematically depicted. The depicted portion of the glass article 100 has a first surface 110 and a second surface 112 spaced apart by a thickness T of the glass article 100.

In some embodiments, the glass article has a thickness of about 0.3 mm to about 2.0 mm thick. For example, the glass article can have a thickness of about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm thick, about 1.9 mm, or about 2.0 mm. In some embodiments, the glass article has a thickness of about 0.5 and 1.8 mm. In some embodiments, the glass article has a thickness of greater than about 1.5 mm.

The glass article may be selected based on its CTE at a particular temperature or its average CTE over a temperature range (e.g., 0° C. to 400° C., 0° C. to 300° C., 0° C. to 260° C., 20° C. to 300° C., or 20° C. to 260° C.), its UV transmission, its Young's modulus, or other properties that may be desired for processing or use of the glass article. Suitably, the glass articles have a CTE between 10.0 and 13.0 ppm/° C. and a Young's modulus of between 65 GPa and 75 GPa, such as those described herein for the glass compositions.

In some embodiments, the glass article has an average optical transmission of greater than 20% over a range of wavelengths from about 250 nm to about 260 nm for a glass article thickness of 1 mm. In some embodiments, the glass article has an average optical transmission of greater than 22% over a range of wavelengths from about 250 nm to about 260 nm for a glass article thickness of 1 mm. In some embodiments, the glass article has an average optical transmission of greater than 25% over a range of wavelengths from about 250 nm to about 260 nm for a glass article thickness of 1 mm. In some embodiments, the glass article has an average optical transmission of about 20% to about 70% over a range of wavelengths from about 250 nm to about 260 nm for a glass article thickness of 1 mm. In some embodiments, the glass article has an average optical transmission of about 20% to about 55% over a range of wavelengths from about 250 nm to about 260 nm for a glass article thickness of 1 mm.

A device can be formed comprising the glass article of the aforementioned glass compositions. Exemplary devices can include, but are not limited to, an electronic device, an automotive device, an architectural device, or an appliance device. The glass article can be formed into a glass carrier for use in fan-out packaging. The glass article can be 3-D formed into complex shapes.

### Methods

A variety of methods may be used to produce the glass compositions and articles described herein. For example, the oxide mixture of the glass composition can be melted at a suitable temperature over a suitable period of time and then poured into a mold and annealed. In some embodiments, the glass articles may be prepared using various methods including, without limitation, float draw process, casting, rolling, slot draw process or fusion draw process. Suitable methods for making glass compositions are known in the art. Liquidus viscosity and refractory compatibility are the some of the factors used to determine suitable manufacturing platform.

In some embodiments, the glass article may be produced by methods which include: melting a batch and forming a precursor glass comprising from about 50 mol. % to about 70 mol. % SiO₂, from about 5 mol. % to about 10 mol. % Al₂O₃, from about 10 mol. % to about 25 mol. % Na₂O, and from about 2 mol. % to about 6 mol. % K₂O; floating the precursor glass on a molten tin bath; annealing the precursor glass to form the glass article; and cooling the glass article to room temperature; wherein the glass article has a Young's modulus of at least 65 GPa; and wherein the glass article has a coefficient of thermal expansion between 10.0 and 13.0 ppm/° C.

In some embodiments, the method can include ion exchanging the glass article in an alkali-ion containing salt bath. In some embodiments, the alkali-ion containing salt bath comprises KNO₃, NaNO₃, or a mixture thereof. In certain embodiments, methods like overflow fusion process may be used, instead of floating. For example, the glass can be melted in a refractory melter, passed through a finer (such as a platinum finer), and delivered to a refractory isopipe. An example of such process and apparatus is disclosed in PCT Publication WO2003/051783 (Corning Inc.), which is incorporated herein by reference in its entirety. In some embodiments, the annealing step is conducted at a temperature of about 450° C. to about 600° C., such as from about 475° C. to about 600° C., from about 500° C. to about 600° C., from about 525° C. to about 600° C., from about 550° C. to about 600° C., from about 575° C. to about 600° C., from about 475° C. to about 575° C., from about 500° C. to about 575° C., from about 525° C. to about 575° C., from about 550° C. to about 575° C., from about 475° C. to about 550° C., from about 500° C. to about 550° C., from about 525° C. to about 550° C., from about 475° C. to about 525° C., from about 500° C. to about 525° C., or from about 475° C. to about 500° C., or any range including and/or in-between any two of these values.

In some embodiments, provided is a method of producing a sheet glass having super clean, flat and smooth surfaces by melting a batch of the precursor glass materials described herein in a tank and forming a precursor glass melt. The melt then flows from the tank into a shallow trough at a rate such that the melt overfills the trough and flows over each side, and rejoins just below the trough to form a single sheet of glass as it cools. The sheet is drawn by a drawing equipment and the thickness of the sheet of glass is controlled by the pull rate of the drawing equipment. Exemplary fusion draw methods and apparatus suitable for producing the glass articles of the present technology are described for example in U.S. Pat. Nos. 3,338,696 and 3,682,609, and also in J. E. Shelby, “Introduction to Glass Science and Technology, The Royal Society of Chemistry, 2005 and A. K. Varshneya, “Fundamentals of Inorganic Glasses, Academic Press, Inc., Boston, 1994, each of which is incorporated herein by reference in its entirety.

In some embodiments, provided is a method which includes melting batch materials to form molten glass; delivering the molten glass to a forming apparatus that has a body with an inlet that receives the molten glass which flows into a trough formed in the body and then overflows two top surfaces of the trough and runs down two sides of the body before fusing together where the two sides come together to form a glass sheet and drawing the glass sheet using a pull roll assembly to produce said glass substrate. In some embodiments, the delivering step includes managing a mass flow rate of molten glass that flows over a predetermined length at both end sections of the trough in the forming apparatus. An example of such process and apparatus is disclosed in PCT Publication WO2005121035 (Corning Inc.), which is incorporated herein by reference in its entirety.

The glass article may alternatively be produced by methods which include: melting a batch and forming a precursor glass comprising from about 50 mol. % to about 70 mol. % SiO₂, from about 5 mol. % to about 10 mol. % Al₂O₃, from about 10 mol. % to about 25 mol. % Na₂O; and from about 2 mol. % to about 6 mol. % K₂O; flowing the precursor glass from a trough that has sides attached to a wedge shaped structure that has downwardly sloping sides converging at a bottom of the wedge shaped structure such that an article is formed when the precursor glass flows over sides of the trough, down the downwardly sloping sides of the wedge shaped structure, and meets at the bottom of the wedge shaped structure; and cooling the glass article to room temperature; wherein the glass article has a Young's modulus of at least 65 GPa; and wherein the glass article has a coefficient of thermal expansion between 10.0 and 13.0 ppm/° C. In some embodiments, the method can include ion exchanging the glass article in an alkali-ion containing salt bath. In some embodiments, the alkali-ion containing salt bath comprises KNO₃, NaNO₃, or a mixture thereof. Such methods are suitable for making single glass sheet articles and are described in for example U.S. Pat. No. 6,748,765, which is incorporated by reference herein in its entirety.

The glass articles described herein may be used in various devices such for example, an electronic device, an automotive device, an architectural device, or an appliance device. For example, the glass article can be used as a glass substrate or glass carrier in fan-out packaging process. The glass article can be used as a glass substrate or glass carrier in a variety of process flows for fan-out wafer or panel level packing processes known in the art, for example, as described in U.S. Pat. Nos. 6,727,576 and 9,000,584, and T. Braun, et al., “Large-area compression molding for fan-out panel-level packing,” Proc. of IEEE/ECTC, 2015, pp. 1077-1083, all of which are hereby incorporated in their entirety by reference

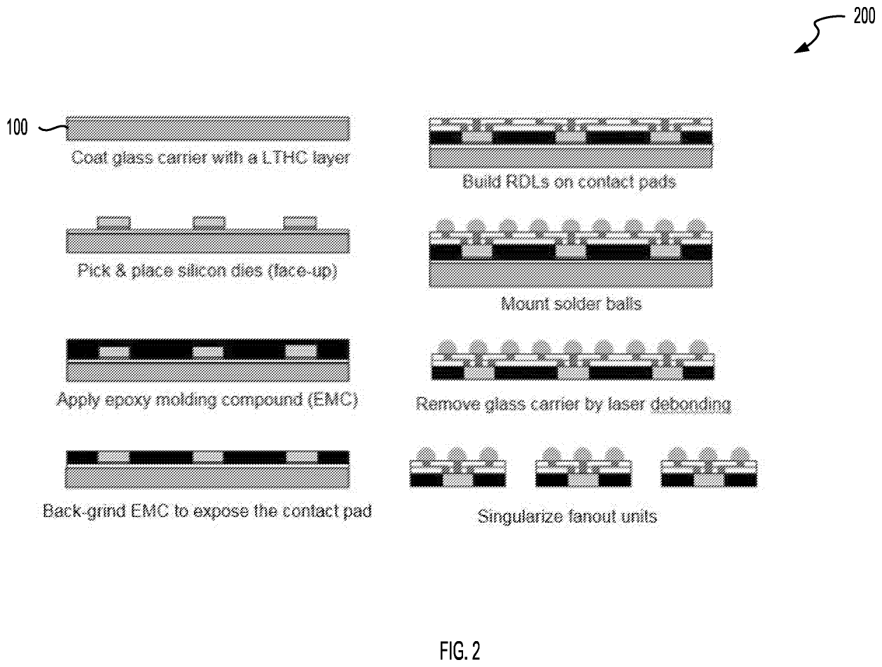

Referring now to FIG. 2, an exemplary schematic flow diagram of a fan-out wafer level packing process 200 is provided. The process can include coating the glass article 100 with a light-to-heat conversion (LTHC) layer (e.g., coating, etc.). The glass article 100 may be a glass substrate. The process 200 can include placing silicon dies on the LTHC layer. The process can include applying an epoxy molding compound (EMC) onto the LTHC layer and silicon dies. The process can include back-grinding the EMC to expose the contact pads. The process can include building redistribution layers (RDLs) on the contact pads. The process can include mounting solder balls onto the RDLs. The process can include removing the glass article 100. Removing the glass article 100 can include removing the glass substrate through laser debonding, two-side thermal release tape, or applying light-to-heat conversion release coating with UV laser debonding. The process can include singularizing the fan-out units.

In various embodiments, a reconstituted wafer- and/or panel-level package is described as comprising a glass article comprising a plurality of cavities and a microelectronic component positioned in each one of the plurality of cavities in the glass article. It should be noted that such a reconstituted wafer- and/or panel-level package may have additional cavities with or without microelectronic components positioned therein. For example, in some embodiments, a reconstituted wafer- and/or panel-level package includes a plurality of cavities with a microelectronic component positioned in each one of the plurality of cavities and one or more additional cavities that are free of a microelectronic component positioned therein. In other embodiments, a reconstituted wafer- and/or panel-level package includes a plurality of cavities with a microelectronic component positioned in each one of the plurality of cavities and is free of additional cavities.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

It will be apparent to those skilled in the art that various modifications and variations can be made without departing from the spirit or scope of the claimed subject matter. Accordingly, the claimed subject matter is not to be restricted except in light of the attached claims and their equivalents.

### EXAMPLES

Various embodiments will be further clarified by the following examples, which are in no way intended to limit this disclosure thereto.

### Example 1: Glass Compositions

Table 1 provides examples of representative compositions according to the present technology. Exemplary glasses described herein exhibit a base composition comprising, in mole percent, of the constituents listed in Table 1. Various properties of the glasses are also set forth in Table 1. These glass properties were determined in accordance with techniques conventional in the glass art. The average linear coefficient of thermal expansion (CTE) in terms of ppm/° C. over the temperature range 0-300° C. was measured using a pushrod dilatometer (ASTM E228). The strain, anneal and softening points are expressed in terms of ° C. They were determined from fiber elongation techniques (ASTM C336 and C338). The density in terms of grams/cm³ was measured via the Archimedes method (ASTM C693). The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for a suitable period of time (e.g., 24 hours, 48 hours, 72 hours, etc.), and determining by means of microscopic examination the highest temperature at which crystals appear in the interior of the glass. The liquidus viscosity in poises was determined from the liquidus temperature and the coefficients of the Fulcher equation. Young's modulus values in terms of Mpsi or GPa were determined using a resonant ultrasonic spectroscopy technique of the general type set forth in ASTM C623. Other properties were measured using standard procedures known in the art.

TABLE 1

| | | | | | | | | | | | Glass |
|---|---|---|---|---|---|---|---|---|---|---|---|
| | M | N | O | P | Q | R | W | S | V | X | A |
| SiO₂ | 62.49 | 63.24 | 62.44 | 61.42 | 60.01 | 61.19 | 64.67 | 63.24 | 63.99 | 64.11 | |
| B₂O₃ | 0.00 | 0.00 | 0.00 | 0.00 | 0.00 | 0.00 | 1.99 | 0.00 | 0.00 | 0.00 | |
| Al₂O₃ | 8.73 | 8.66 | 8.70 | 8.63 | 8.57 | 8.57 | 5.62 | 7.40 | 5.56 | 3.71 | |
| P₂O₅ | 0.00 | 0.00 | 0.00 | 0.00 | 0.00 | 0.00 | 0.00 | 1.98 | 1.99 | 1.96 | |
| Na₂O | 16.64 | 16.74 | 17.65 | 17.73 | 18.33 | 17.81 | 17.78 | 17.67 | 18.25 | 19.02 | |
| K₂O | 2.85 | 3.84 | 3.85 | 4.85 | 4.86 | 4.84 | 3.81 | 3.11 | 4.03 | 4.00 | |
| MgO | 0.02 | 0.02 | 0.02 | 0.02 | 2.27 | 3.12 | 4.07 | 4.33 | 4.16 | 5.17 | |
| CaO | 0.00 | 0.00 | 0.00 | 0.00 | 0.00 | 0.00 | 1.94 | 0.04 | 1.92 | 1.92 | |
| SrO | 0.00 | 0.00 | 0.00 | 0.00 | 0.00 | 0.00 | 0.00 | 0.00 | 0.00 | 0.00 | |
| SnO₂ | 0.21 | 0.21 | 0.21 | 0.21 | 0.21 | 0.21 | 0.11 | 0.11 | 0.11 | 0.11 | |
| Fe₂O₃ | 0.004 | 0.004 | 0.004 | 0.004 | 0.004 | 0.005 | 0.00 | 0.001 | 0.001 | 0.001 | |
| ZnO | 9.05 | 7.28 | 7.11 | 7.13 | 5.73 | 4.24 | 0.00 | 2.13 | 0.00 | 0.00 | |
| ZrO₂ | 0.00 | 0.00 | 0.00 | 0.00 | 0.00 | 0.00 | 0.00 | 0.00 | 0.00 | 0.00 | |
| TiO₂ | 0.01 | 0.01 | 0.01 | 0.01 | 0.01 | 0.01 | 0.00 | 0.00 | 0.00 | 0.00 | |
| Total | 100.00 | 100.00 | 100.00 | 100.00 | 99.99 | 99.99 | 100.00 | 100.00 | 100.00 | 100.00 | |
| Total alkali | 19.49 | 20.59 | 21.50 | 22.58 | 23.19 | 22.65 | 21.59 | 20.77 | 22.28 | 23.02 | |
| Liquidus Temp | <910 | 815 | 790 | <825 | <845 | <850 | <835 | 1045 | 1060 | 1020 | |
| Point (° C.) | | | | | | | | | | | |
| Liquidus | | Albite | Albite | | | | | Unknown/ | Unknown/ | Unknown/ | |
| Phase | | | | | | | | Phase | Phase | Phase | |
| | | | | | | | | separation | separation | separation | |
| Density (RT, | 2.629 | 2.602 | 2.601 | 2.614 | 2.585 | 2.566 | 2.497 | 2.498 | 2.478 | 2.485 | |
| g/cm³) | | | | | | | | | | | |
| CTE (0-300° C., | 10.2 | 10.7 | 10.9 | 11.4 | 11.3 | 11.4 | 11.0 | 10.7 | 11.7 | 12.2 | |
| ppm/° C.) | | | | | | | | | | | |
| Strain Point | 530 | 508 | 501 | 490 | 490 | 489 | 469 | 478 | 453 | 435 | |
| (° C.) | | | | | | | | | | | |
| Anneal Point | 574 | 555 | 544 | 533 | 532 | 532 | 505 | 521 | 494 | 475 | |
| (° C.) | | | | | | | | | | | |
| Softening | 769.9 | 754 | 738.2 | 724 | 726.4 | 726.9 | — | — | 709 | 655.4 | |
| Point (° C.) | | | | | | | | | | | |
| Poisson's Ratio | 0.225 | 0.226 | 0.227 | 0.23 | 0.23 | 0.228 | 0.229 | 0.225 | 0.225 | 0.228 | |
| Shear Modulus | 4.21 | 4.18 | 4.17 | 4.16 | 4.17 | 4.18 | 4.21 | 4.05 | 4.05 | 3.99 | |
| (Mpsi) | | | | | | | | | | | |
| Young's Modulus | 10.32 | 10.25 | 10.23 | 10.24 | 10.26 | 10.26 | 10.35 | 9.93 | 9.93 | 9.81 | |
| (Mpsi) | | | | | | | | | | | |
| Young's Modulus | 71.2 | 70.7 | 70.5 | 70.6 | 70.7 | 70.7 | 71.4 | 68.5 | 68.5 | 67.6 | |
| (GPa) | | | | | | | | | | | |

### Example 2: Optical Transmission % Vs. Wavelength

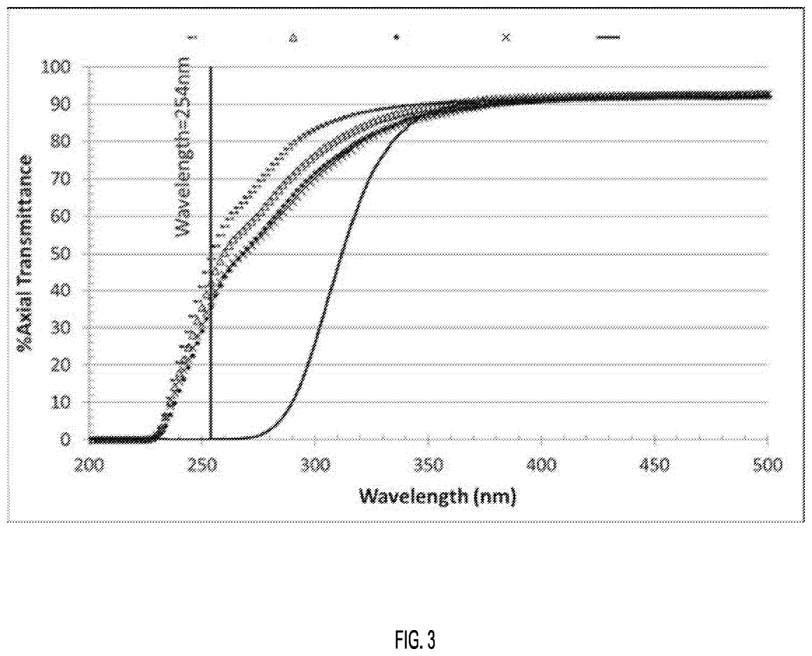

A glass article having a total thickness of 1 mm was formed using the compositions (S, V, W, and X) provided in Table 1, and the transmittance of light having a wavelength from 200 nm to 500 nm was measured. Additionally, the transmittance of light having a wavelength from 200 nm to 500 nm was measured for a standard Corning© production glass (Glass A), which is a lithium containing alumina-phosphorus silicate glass having a total thickness of 1 mm. The results are shown in FIG. 3.

As shown in FIG. 3, the glass article achieves a transmission of greater than 60% over the wavelengths from 300 nm to 400 nm, which is the range of wavelengths used by various UV-debonding technologies. Accordingly, the glass article is compatible with UV-debonding processes employed by various semiconductor manufacturers. The glass article achieves a transmission of greater than 20% over the wavelengths from about 250 nm to about 260 nm. Compared to the standard Corning® production glass (Glass A), the articles having the compositions (S, V, W, and X) provided in Table 1 achieve a greater transmission at wavelengths less than 325 nm.

### Example 3: Optical Transmission % at 254 nm Vs. Fe₂O₃ Concentration

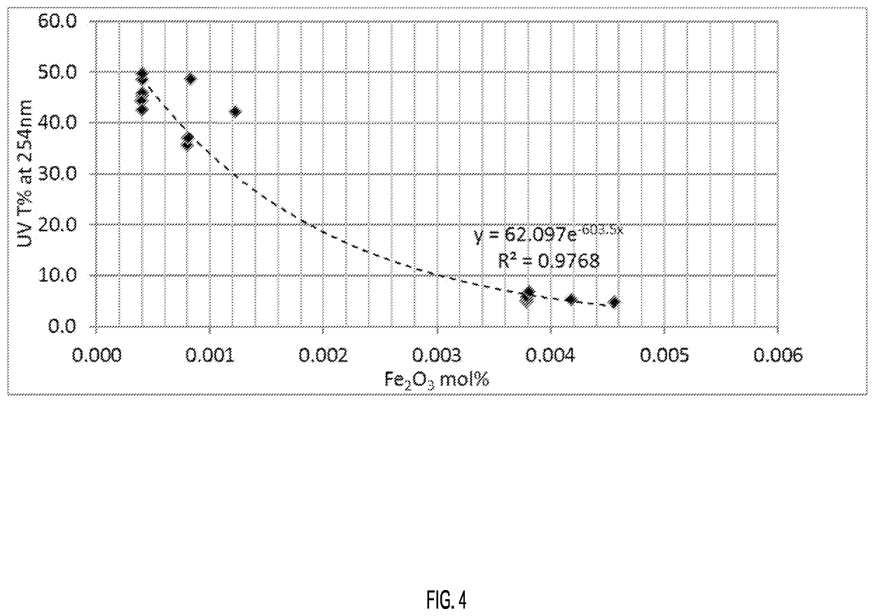

A glass article having a total thickness of 1 mm was formed using the compositions provided in Table 1, and the transmittance of light having a wavelength of 254 nm as a function of Fe₂O₃ concentration (in mol. %) was measured. The results are shown in FIG. 4. As shown in FIG. 4, the transmittance of light at 254 nm decreases with increasing Fe₂O₃ content.

### Definitions

The term “coefficient of thermal expansion” or “CTE” is an average linear CTE over a particular range of temperatures. In various embodiments, the coefficient of thermal expansion of the glass composition is averaged over a temperature range from about 0° C. to about 300° C. In some embodiments, the coefficient of thermal expansion of the glass composition is averaged over a temperature range from about 20° C. to about 260° C.

In some embodiments, such as when the glass is flameworkable, the CTE may be measured over a temperature range of 0° C. to 300° C. via dilatometer. The glass is flameworked to a particular size with pointed tips. The sample is first immersed in a zero-degree ice bath, and then to a 300° C. bath, with the length of the sample being measured at each time. The CTE is then calculated based on the two measurements.

In other embodiments, such as when the glass is not flameworkable (e.g., glass laminates), the CTE may be measured over a temperature range of 20° C. to a maximum of 1000° C. via dilatometer. The glass is machined to a particular size with very flat ends and is placed in a small furnace which is heated up and cooled down with pre-determined rate (for example, 4° C./min up, a 5 minute temperature hold, and 4° C./min down), and the temperature and the length of sample is measured real time. A thermal expansion curve during both heating and cooling can be obtained. The average CTE number over a certain temperature range can be obtained from this measurement from both the heating and cooling curve.

The elastic modulus (also referred to as Young's modulus) of the substrate is provided in units of gigapascals (GPa). The elastic modulus of the substrate is determined by resonant ultrasound spectroscopy on bulk samples of the substrate.

The term “softening point” as used herein, refers to the temperature at which the viscosity of the glass composition is 1×10^{7.6} poise.

The term “annealing point” and “anneal point” as used herein, refers to the temperature at which the viscosity of the glass composition is 1×10¹³ poise.

The terms “strain point” as used herein, refers to the temperature at which the viscosity of the glass composition is 3×10¹⁴ poise.

As used herein, “transmission”, “transmittance”, “optical transmittance” and “total transmittance” are used interchangeably in the disclosure and refer to external transmission or transmittance, which takes absorption, scattering and reflection into consideration. Fresnel reflection is not subtracted out of the transmission and transmittance values reported herein. In addition, any total transmittance values referenced over a particular wavelength range are given as an average of the total transmittance values measured over the specified wavelength range. Further, as also used herein, “average absorbance” is given as:

$$\frac{2 - log ( average transmittance , \% )}{path length}$$

Concentration profiles of various constituent components in the glass, such as alkali constituent components, were measured by electron probe microanalysis (EPMA). EPMA may be utilized, for example, to discern compressive stress in the glass due to the ion exchange of alkali ions into the glass.

The terms “glass” and “glass composition” encompass both glass materials and glass-ceramic materials, as both classes of materials are commonly understood. Likewise, the term “glass structure” encompasses structures comprising glass. The term “reconstituted wafer- and/or panel-level package” encompasses any size of reconstituted substrate package including wafer level packages and panel level packages.

The term “formed from” can mean one or more of comprises, consists essentially of, or consists of. For example, a component that is formed from a particular material can comprise the particular material, consist essentially of the particular material, or consist of the particular material.

As used herein, the term “ion exchanged”, “ion-exchanged”, or “ion-exchangeable” is understood to mean treating the glass with a heated solution containing ions having a different ionic radius than ions that are present in the glass surface and/or bulk, thus replacing those ions with, for example, smaller ions. For example, potassium can go in the glass to replace the sodium ions.

Directional terms as used herein—for example up, down, right, left, front, back, top, bottom, vertical, horizontal—are made only with reference to the figures as drawn and are not intended to imply absolute orientation unless otherwise expressly stated.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items. Moreover, terms used in the specification and claims such as have, having, include, and including should be construed to be synonymous with the terms comprise and comprising. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in some embodiments, to Y only (optionally including elements other than X); in yet some embodiments, to both X and Y (optionally including other elements).

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the invention described herein can be used in any combination. Moreover, the disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and biological equivalents thereof.

All patents, patent applications, provisional applications, and publications referred to or cited herein are incorporated by reference in their entirety, including all figures and tables, to the extent they are not inconsistent with the explicit teachings of this specification.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

When a composition herein is given a range of 0-Z wt. %, this range refers to the amount of material added to a batch and excludes contaminant levels of the same material. As those skilled in the art would appreciate, metals, for example, sodium and iron, are frequently found at contaminant levels in batched glass and glass products. Consequently, it is to be understood that in those cases where a material is not specifically added to a batch, added, any such material that may be present in an analyzed sample of the final glass material is contaminant material. Except for iron oxides, where contaminant levels are typically around the 0.03 wt. % (300 ppm) level, contaminant levels are less than 0.005 wt. % (50 ppm). The term “consistently essentially of” is to be understood as not including contaminant levels of any material.

1. A glass composition comprising:
from about 50 mol. % to about 70 mol. % SiO₂;
from about 5 mol. % to about 10 mol. % Al₂O₃;
from about 10 mol. % to about 20 mol. % Na₂O; and
from about 2 mol. % to about 6 mol. % K₂O;
from about 0 mol. % to about 0.005 mol. % Fe₂O₃;
from about 2 mol. % to about 10 mol. % ZnO;
wherein the glass composition comprises R¹O and the sum of R¹O and ZnO is greater than about 4 mol. %, wherein R¹ is an alkaline earth metal;
wherein the glass composition has a Young's modulus of at least 65 GPa; and
wherein the glass composition has a coefficient of thermal expansion between 10.0 and 13.0 ppm/° C.

2. The glass composition of claim 1, wherein the glass composition has an optical transmission of greater than about 20% over a range of wavelengths from about 250 nm to about 260 nm for a glass article thickness of about 1.0 mm.

3. The glass composition of claim 1, further comprising:
from about 0 mol. % to about 2 mol. % B₂O₃;
from about 0 mol. % to about 3 mol. % P₂O₅;
from about 0 mol. % to about 0.5 mol. % Li₂O;
from about 0 mol. % to about 6 mol. % MgO;
from about 0 mol. % to about 3 mol. % CaO;
from about 0 mol. % to about 3 mol. % SrO;
from about 0 mol. % to about 0.5 mol. % SnO₂;
from about 0 mol. % to about 0.002 mol. % Fe₂O₃;
from about 0 mol. % to about 2 mol. % BaO; and
from about 4 mol. % to about 10 mol. % ZnO.

4. The glass composition of claim 3, comprising from about 0 mol. % to about 2 mol. % P₂O₅.

5. (canceled)

6. The glass composition of claim 1, wherein the glass composition comprises R₂O and Al₂O₃ and the difference between R₂O and Al₂O₃ is from about 9 mol. % to about 15 mol. %, wherein R is an alkali metal.

7. The glass composition of claim 6, wherein R is selected from Na, K, or a combination thereof.

8. The glass composition of claim 1, wherein the sum of R¹O and ZnO is from about 6 mol. % to about 8 mol. %, wherein R¹ is selected from Mg, Ca, Sr, Ba, or a combination thereof.

9. (canceled)

10. The glass composition of claim 1, wherein the Young's modulus of the glass composition is less than 75 GPa.

11. (canceled)

12. (canceled)

13. The glass composition of claim 1, wherein a total alkali content is from about 12 mol. % to about 26 mol. %.

14. (canceled)

15. (canceled)

16. (canceled)

17. A method for manufacturing a glass article comprising:
(a) melting a batch and forming a precursor molten glass comprising:
from about 50 mol. % to about 70 mol. % SiO₂;
from about 5 mol. % to about 10 mol. % Al₂O₃;
from about 10 mol. % to about 25 mol. % Na₂O; and
from about 2 mol. % to about 6 mol. % K₂O;
from about 0 mol. % to about 0.005 mol. % Fe₂O₃;
from about 2 mol. % to about 10 mol. % ZnO;
wherein the glass composition comprises R¹O and the sum of R¹O and ZnO is greater than about 4 mol. %, wherein R¹ is an alkaline earth metal;
(b) delivering the molten glass to a forming apparatus that has a body with an inlet that receives the molten glass which flows into a trough formed in the body and then overflows two top surfaces of the trough and runs down two sides of the body before fusing together where the two sides come together to form a glass sheet; and
(c) drawing the glass sheet using a pull roll assembly to produce said glass substrate;
wherein the glass article has a Young's modulus of at least 65 GPa; and
wherein the glass article has a coefficient of thermal expansion between 10.0 and 13.0 ppm/° C.

18. The method of claim 17, further comprising ion exchanging the glass article in an alkali-ion containing salt bath.

19. The method of claim 18, wherein the alkali-ion containing salt bath comprises KNO₃, NaNO₃, or a mixture thereof.

20. The method of claim 17, wherein the delivering step includes managing a mass flow rate of molten glass that flows over a predetermined length at both end sections of the trough in the forming apparatus.

21. The method of claim 17, wherein the glass article has an optical transmission of greater than about 20% over a range of wavelengths from about 250 nm to about 260 nm for a glass article thickness of about 1.0 mm.

22. The method of claim 17, wherein the glass article comprises:
from about 0 mol. % to about 2 mol. % B₂O₃;
from about 0 mol. % to about 3 mol. % P₂O₅;
from about 0 mol. % to about 0.5 mol. % Li₂O;
from about 0 mol. % to about 6 mol. % MgO;
from about 0 mol. % to about 3 mol. % CaO;
from about 0 mol. % to about 3 mol. % SrO;
from about 0 mol. % to about 0.5 mol. % SnO₂;
from about 0 mol. % to about 0.002 mol. % Fe₂O₃;
from about 0 mol. % to about 2 mol. % BaO; and
from about 4 mol. % to about 10 mol. % ZnO.

23. The method of claim 22, wherein the glass article comprises from about 0 mol. % to about 2 mol. % P₂O₅.

24. (canceled)

25. The method of claim 17, wherein the glass article comprises R₂O and Al₂O₃ and the difference between R₂O and Al₂O₃ is from about 9 mol. % to about 15 mol. %, wherein R is an alkali metal.

26. The method of claim 25, wherein R is selected from Na, K, or a combination thereof.

27. The method of claim 17, wherein the sum of R¹O and ZnO is from about 6 mol. % to about 8 mol. %, wherein R¹ is selected from Mg, Ca, Sr, Ba, or a combination thereof.

28. (canceled)

29. The method of claim 17, wherein the Young's modulus of the glass article is less than 75 GPa.

30. (canceled)

31. The method of claim 17, wherein a total alkali content of the glass article is from about 12 mol. % to about 26 mol. %.

32. (canceled)

33. (canceled)
